(19) United States
(12) Patent Application Publication
(10) Pub. No.: US 2007/0076077 A1
(43) Pub. Date: Apr. 5, 2007

(54) Method for forming a pattern and liquid ejection apparatus

(75) Inventor: Hirotsuna Miura, Fujimi (JP)

Correspondence Address: HARNESS, DICKEY & PIERCE, P.L.C., P.O. BOX 828, BLOOMFIELD HILLS, MI, 48303, US

(73) Assignee: Seiko Epson Corporation

(21) Appl. No.: 11/541,939

(22) Filed: Oct. 2, 2006

(30) Foreign Application Priority Data
Oct. 4, 2005 (JP) 2005-291559

(51) Int. Cl. B41J 2/01; B23K 26/00

(52) U.S. Cl. 347/102; 219/121.85

(57) ABSTRACT

A laser head is provided in the vicinity of an ejection head. A laser beam radiated by the laser head reaches a substrate reflecting position on a surface of the substrate at a critical angle and is then totally reflected by the substrate toward the ejection head. After having been reflected by the substrate, the laser beam is totally reflected by a reflective surface of a nozzle plate toward the substrate. The laser beam thus reaches a radiating position on the surface of the substrate at a radiating angle (the critical angle).

### CROSS-REFERENCE TO RELATED APPLICATIONS

This application is based upon and claims the benefit of priority from prior Japanese Patent Application No. 2005-291559, filed on Oct. 4, 2005, the entire contents of which are incorporated herein by reference.

### BACKGROUND

1. Technical Field

The present invention relates to a method for forming a pattern and a liquid ejection apparatus.

2. Related Art

Typically, a display such as a liquid crystal display or an electroluminescence display includes a substrate that displays an image. The substrate has an identification code (for example, a two-dimensional code) representing encoded information including the site of production and the product number. The identification code is formed by structures (dots formed by colored thin films or recesses) that reproduce the identification code. The structures are provided in multiple dot formation areas (data cells) in accordance with a prescribed pattern.

As a method for forming the identification code, a laser sputtering method and a waterjet method have been described in JP-A-11-77340 and JP-A-2003-127537. In the laser sputtering method, films forming a code pattern are provided through sputtering. The waterjet method involves ejection of water containing abrasive material onto a substrate for marking a code pattern on the substrate.

However, to form the code pattern in a predetermined size by the laser sputtering method, the interval between a metal foil and a substrate must be adjusted to several or several tens of micrometers. The corresponding surfaces of the substrate and the metal foil thus must be extremely flat and the interval between the substrate and the metal foil must be adjusted with accuracy of the order of micrometer. Therefore, the laser sputtering method is applicable only to certain types of substrates, making it difficult to form identification codes in a wider range of substrates. In the waterjet method, water or dust or abrasive may splash onto and contaminate a substrate, when forming a code pattern on the substrate.

To solve these problems, an inkjet method has been focused on as an alternative method for forming an identification code. In the inkjet method, droplets of liquid containing metal particles are ejected from a nozzle. The droplets are then dried and thus form dots. The inkjet method is applicable to a wider variety of substrates and prevents contamination of the substrates caused by formation of the identification codes.

However, when drying droplets on a substrate, the inkjet method may have the following problem caused by the surface condition of the substrate or the surface tension of each droplet. Specifically, after having been received by the surface of the substrate, the droplet may spread wet on the substrate surface as the time elapses. Therefore, if the time necessary for drying the droplet exceeds a predetermined level (for example, 100 milliseconds), the droplet may spread beyond the corresponding data cell and reaches an adjacent data cell. This may lead to erroneous formation of the code pattern.

The problem may be avoided by radiating a laser beam onto a droplet of liquid on a substrate and quickly drying the droplet. However, as illustrated in FIG. 9, when a droplet Fb is located immediately below a liquid ejection head 101, a laser beam B must be radiated onto the droplet Fb on a substrate 102 through a narrow gap between the liquid ejection head 101 and the substrate 102. In other words, radiation of the laser beam B must be performed with the optical axis A of the laser beam B greatly inclined with respect to the normal line H of the substrate 102. In this case, as the inclination angle of the optical axis A increases, the beam spot of the laser beam B projected on the surface of the substrate enlarges. This lowers the radiation intensity of the laser beam B and decreases accuracy of the radiating position of the laser beam B.

### SUMMARY

Accordingly, it is an objective of the present invention to provide a method for forming a pattern and a liquid ejection apparatus that increases the radiation intensity and accuracy of the radiating position of a laser beam and enhances controllability of the formation of the pattern.

To achieve the foregoing objectives and in accordance with one aspect of the present invention, a method for forming a pattern by ejecting droplets of a liquid containing a pattern forming material from ejection ports defined in an ejection head opposed to a substrate and radiating a laser beam onto the droplets on the substrate is provided. The method includes: radiating the laser beam onto the substrate and reflecting the laser beam by the substrate; and reflecting the laser beam that has been reflected by the substrate onto areas of the substrate in which the droplets have been received by the substrate by a reflecting member provided in the vicinity of the ejection ports.

In accordance with another aspect of the present invention, a liquid ejection apparatus including an ejection head having an ejection port opposed to a substrate and ejecting a droplet of a liquid from the ejection port and a laser source radiating a laser beam onto the substrate is provided. The apparatus includes a reflecting member that is provided in the vicinity of the ejection port and reflects the laser beam that has been reflected by the substrate. The reflecting member reflects the laser beam that has been reflected by the substrate toward an area of the substrate in which the droplet has been received by the substrate.

Other aspects and advantages of the invention will become apparent from the following description, taken in conjunction with the accompanying drawings, illustrating by way of example the principles of the invention.

### BRIEF DESCRIPTION OF THE DRAWINGS

The invention, together with objects and advantages thereof, may best be understood by reference to the following description of the presently preferred embodiments together with the accompanying drawings in which:

FIG. 1 is a plan view showing a liquid crystal display having a pattern formed by a pattern forming method according to an embodiment of the present invention;

FIG. 2 is a perspective view schematically showing a liquid ejection apparatus;

FIG. 3 is a perspective view schematically showing a liquid ejection head and a laser head;

FIG. 4 is a cross-sectional view schematically showing the liquid ejection head and the laser head;

FIG. 5 is a block diagram representing an electric circuit of the liquid ejection apparatus;

FIG. 6 is a cross-sectional view schematically showing a liquid ejection head and a laser head according to a modification;

FIG. 7 is a cross-sectional view schematically showing a liquid ejection head and a laser head of a modification;

FIG. 8 is a cross-sectional view schematically showing a liquid ejection head and a laser head of another modification; and

FIG. 9 is a cross-sectional view schematically showing a typical liquid ejection apparatus.

### DESCRIPTION OF EXEMPLARY EMBODIMENTS

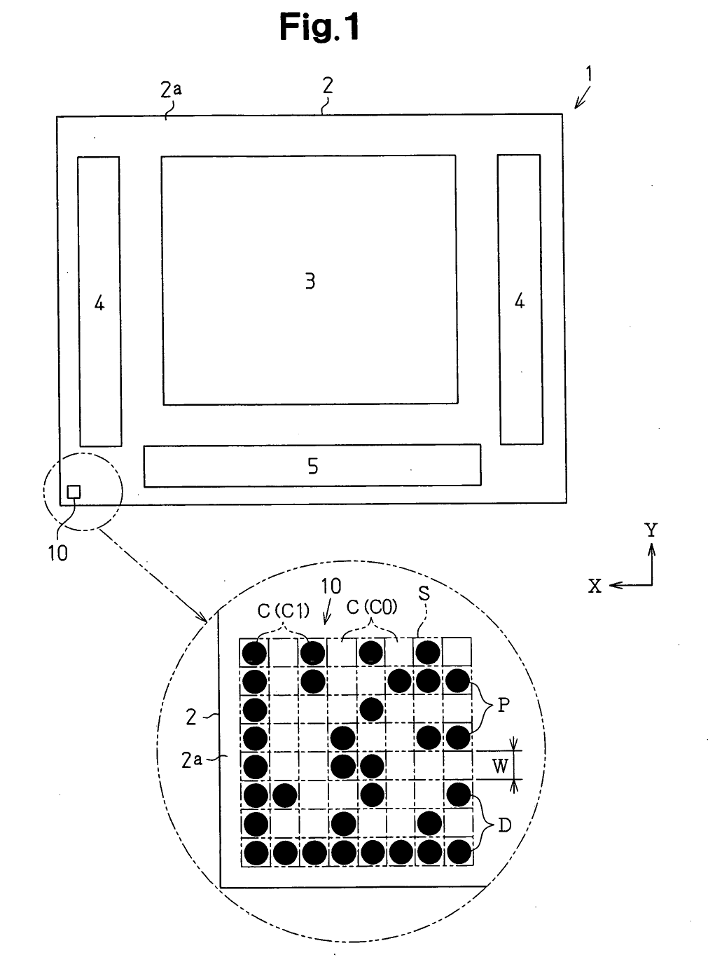

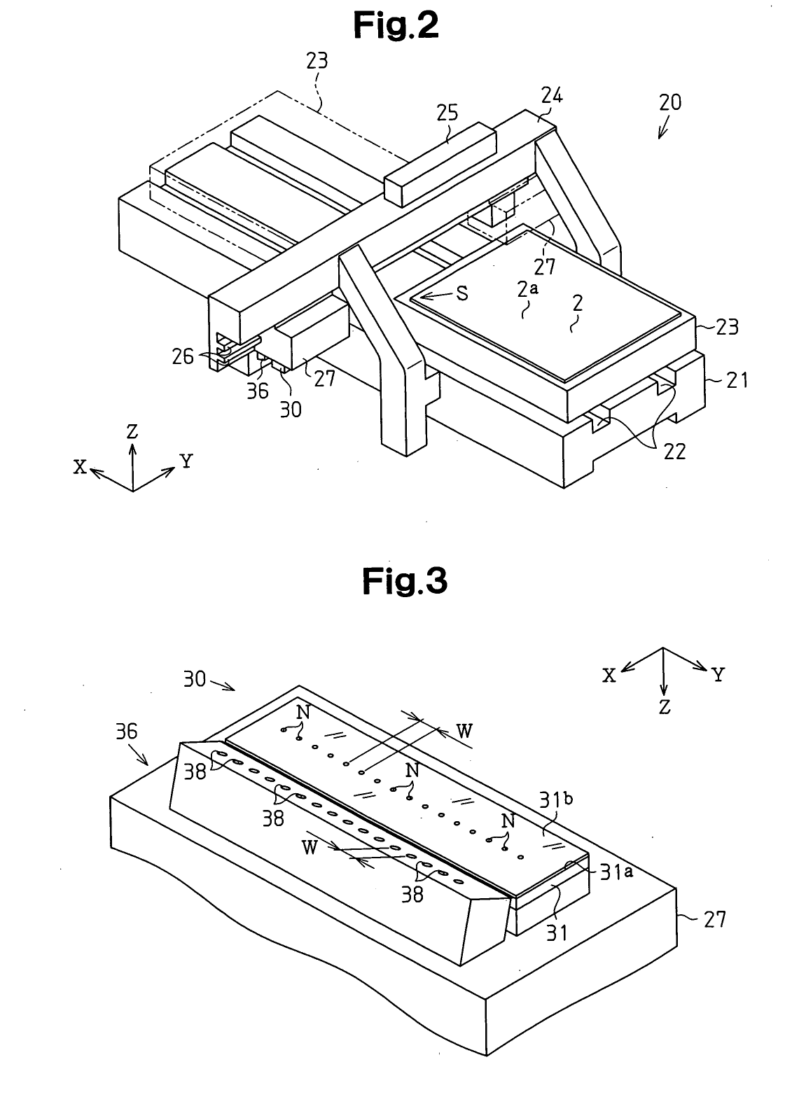

A liquid crystal display that has an identification code formed by a method for forming dots of the present invention will now be described with reference to FIGS. 1 to 5. In the description, direction X, direction Y, and direction Z are defined as illustrated in FIG. 2.

As shown in FIG. 1, a liquid crystal display 1 has a rectangular glass substrate (hereinafter, refereed to as a substrate) 2. A rectangular display portion 3 is formed substantially at the center of a surface 2a of the substrate 2. Liquid crystal molecules are sealed in the display portion 3. A scanning line driver circuit 4 and a data line driver circuit 5 are provided outside the display portion 3. In the liquid crystal display 1, the orientation of the liquid crystal molecules is adjusted in correspondence with a scanning signal generated by the scanning line driver circuit 4 and a data signal produced by the data line driver circuit 5. In accordance with the orientation of the liquid crystal molecules, area light radiated by an illumination device (not shown) is modulated to display an image on the display portion 3 of the substrate 2.

An identification code 10 indicating the product number or the lot number of the liquid crystal display 1 is formed at the left corner of the surface 2a of the substrate 2. The identification code 10 is formed by a plurality of dots D and provided in a code formation area S in accordance with a prescribed pattern. The code formation area S includes 64 data cells, aligned by 8 lines and 8 rows. Each of the data cells C is defined by virtually dividing the code formation area S, which has a square shape of 1 mm×1 mm, into equally sized sections. The dots D are formed in selected ones of the data cells C, thus forming the identification code 10. In the following, each of the cells C in which the dot D is provided is referred to as a black cell C1, or a dot forming position. Each of the empty cells C is referred to as a blank cell C0. The center of each black cell C1 is referred to as an “ejection target position P” and the length of each of the sides of the data cell C is referred to as “cell width W”.

Each of the dots D is formed by ejecting a droplet Fb of liquid containing metal particles (for example, nickel or manganese particles) into the corresponding one of the data cells C (the black cells C1). The droplet Fb is then dried and baked in the cell C, thus providing the dot D. Alternatively, the dot D may be completed simply by drying the droplet Fb in the cell C through radiation of a laser beam.

A liquid ejection apparatus 20 for forming the identification code 10 will hereafter be explained.

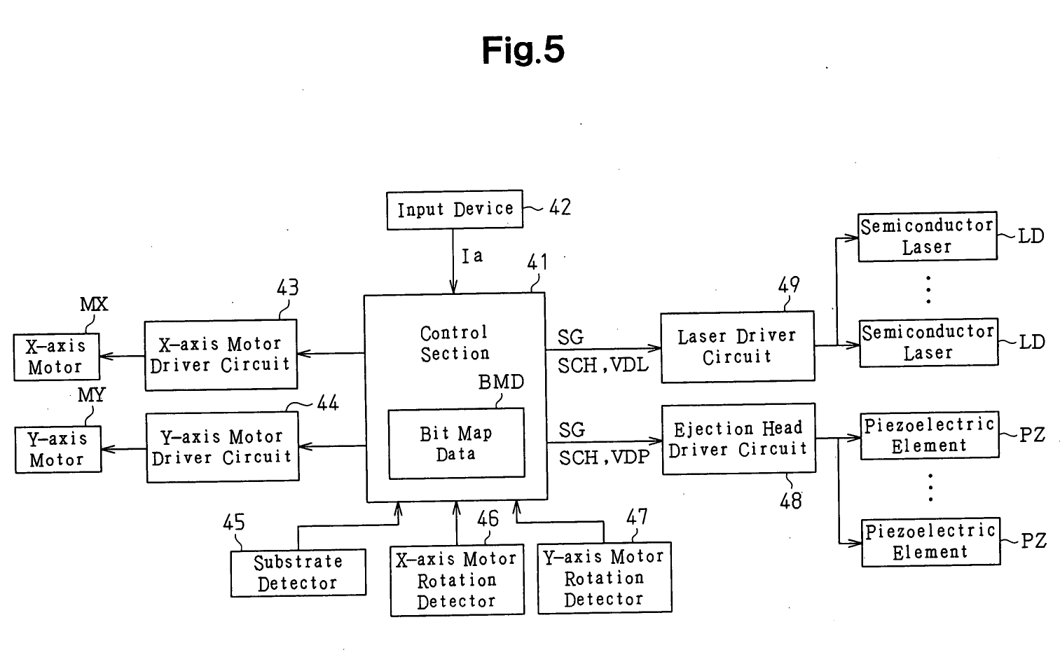

As shown in FIG. 2, the liquid ejection apparatus 20 has a parallelepiped base 21. A pair of guide grooves 22 are defined in the upper surface of the base 21 and extend in direction X. A substrate stage 23 is mounted on the base 21 and operably connected to an X-axis motor MX (see FIG. 5). When the X-axis motor MX runs, the substrate stage 23 moves in direction X or the direction opposite to direction X along the guide grooves 22. A suction type chuck mechanism (not shown) is provided on the upper surface of the substrate stage 23. The chuck mechanism operates to position and fix the substrate 2 on the substrate stage 23 at a predetermined position, with the surface 2a (the code formation area S) facing upward.

A gate-like guide member 24 is secured to opposing sides of the base 21. A reservoir tank 25 retaining liquid F is mounted on the guide member 24. A pair of guide rails 26 extending along direction Y are provided in a lower portion of the guide member 24 and extend in direction Y. A carriage 27 is movably supported by the guide rails 26. The carriage 27 is operably connected to a Y-axis motor MY (see FIG. 5). The carriage 27 moves in direction Y or the direction opposite to direction Y along the guide rails 26. In the following, the position of the carriage 27 indicated by the solid lines of FIG. 2 is referred to as a first position. The position of the carriage 27 indicated by the double-dotted broken lines of FIG. 2 is referred to as a second position.

A liquid ejection head (hereinafter, referred to as an ejection head) 30 ejecting liquid droplets is secured to the lower surface of the carriage 27. FIG. 3 is a perspective view showing the ejection head 30 as viewed from the side corresponding to the substrate 2. As illustrated in FIG. 3, the ejection head 30 includes a nozzle plate 31, a reflection member, formed on the surface (the top surface as viewed in FIG. 3) of the ejection head 30 opposed to the substrate 2. The nozzle plate 31 is formed by a plate member formed of stainless steel. A surface (hereinafter, referred to as a reflective surface) 31a of the nozzle plate 31 opposed to the substrate 2 is formed through mirror-surface machining to allow reflection of the laser beam B on the reflective surface 31a.

The reflective surface 31a of the nozzle plate 31 is coated with a liquid repellent film 31b with a thickness of several hundreds of nanometers. The liquid repellent film 31b is a film transmissible to the laser beam B and formed of a silicone resin or a fluorine resin. The liquid repellent film 31b thus repels the liquid F. In the illustrated embodiment, the liquid repellent film 31b is formed directly on the reflective surface 31a. However, a bonding layer of a thickness of several nanometers formed of a silane coupling agent or the like may be arranged between the reflective surface 31a and the liquid repellent film 31b. The bonding layer improves bonding performance between the reflective surface 31a and the liquid repellent film 31b.

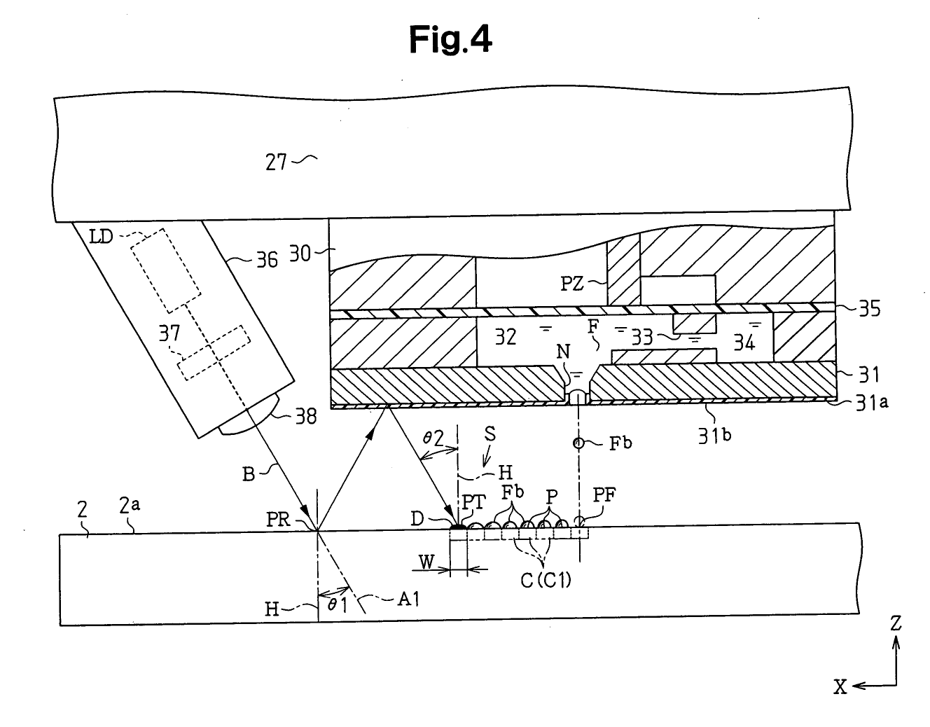

A plurality of nozzles N, or ejection ports, are defined in the nozzle plate 31 and spaced at equal intervals along direction Y. The pitch of the nozzles N is set to a value equal to the pitch of the ejection target positions P (the cell width W of FIG. 1). As shown in FIG. 4, the reflective surface 31a of the nozzle plate 31 is arranged parallel with the surface 2a of the substrate 2. Each of the nozzles N extends in a direction perpendicular to the surface 2a of the substrate 2 and through the nozzle plate 31. In the following, the position of the substrate 2 opposed to each of the nozzles N is referred to as a “droplet receiving position PF”.

Cavities 32 are defined in the ejection head 30. Each of the cavities 32 communicates with the reservoir tank 25 through a corresponding communication bore 33 and a common supply line 34. Therefore, the liquid F in the reservoir tank 25 is supplied to the nozzles N through the corresponding cavities 32. An oscillation plate 35, which oscillates in an upward-downward direction, is provided above each of the cavities 32 in the ejection head 30. Through oscillation of each oscillation plate 35, the volume of the corresponding cavity 32 is increased or decreased. A plurality of piezoelectric elements PZ are arranged on the oscillation plates 35 at positions corresponding to the nozzles N. When any one of the piezoelectric elements PZ repeatedly contracts and extends in an upward-downward direction, the corresponding one of the oscillation plates 35 oscillates in the upward-downward direction.

Specifically, the piezoelectric element PZ contracts and extends when the corresponding black cell C1 (ejection target position P) coincides with the receiving position PF through transportation of the substrate stage 23 in direction X. This increases and decreases the volume of each cavity 32, ejecting the liquid F from the corresponding nozzle N as the droplet Fb by the amount corresponding to the decreased volume of the cavity 32. The droplet Fb then reaches the ejection target position P (the receiving position PF) on the substrate 2, which is arranged immediately below the corresponding nozzle N. After having reached the ejection target position P, the droplet Fb spreads wet as the time elapses and enlarges to the same size as the cell width W. In the following, the center of the droplet Fb (the ejection target position P) when the outer diameter of the droplet Fb becomes equal to the cell width W will be referred to as a “radiating position PT”.

A laser head 36 having a plurality of semiconductor lasers LD is provided in the vicinity of the ejection head 30. The semiconductor lasers LD serve as a laser radiation source. The laser beam B radiated by each of the semiconductor lasers LD has a wavelength range corresponding to the absorption range of the liquid F (including dispersion medium and metal particles). Each semiconductor laser LD has an optical system including a collimator 37 and a collective lens 38. The collimator 37 collimates the laser beam B of each semiconductor laser LD to a parallel flux of light. The collective lens 38 converges the laser beam B that has passed through the collimator 37 and guides the laser beam B to the surface 2a of the substrate 2. The optical axis A1 of the optical system is inclined with respect to the normal line H of the surface 2a of the substrate 2 at a predetermined angle.

After having been radiated from the semiconductor laser LD, the laser beam B is totally reflected by the substrate 2 at the reflecting position PR and led to the reflective surface 31a of the nozzle plate 31. The laser beam B is then reflected also by the reflective surface 31a of the nozzle plate 31 and guided to the radiating position PT of the surface 2a of the substrate 2. This evaporates the dispersion medium from the droplet Fb, suppressing wet spreading of the droplet Fb. Meanwhile, the metal particles in the droplet Fb are baked through continuous radiation of the laser beam B. As a result, a semispherical dot D having an outer diameter equal to the cell width W is formed on the surface 2a of the substrate 2.

In the following, the angle of the optical axis A1 with respect to the normal line H will be referred to as an “incident angle θ1”. The angle of the laser beam B radiated onto the radiating position PT with respect to the normal line H will be referred to as the “radiation angle θ2”. In the illustrated embodiment, the incident angle θ1 corresponds to a minimum reflection angle (a critical angle) at which the laser beam B is totally reflected by the surface 2a (at the reflecting position PR). Further, since the surface 2a of the substrate 2 is arranged parallel with the reflective surface 31a of the nozzle plate 31, the radiation angle θ2 is equal to the incident angle θ1.

According to the present invention, by reflecting the laser beam B by the surface 2a of the substrate 2 and the reflective surface 31a of the nozzle plate 31, the radiation angle θ2 of the laser beam B at the radiating position PT is decreased compared to the typical method illustrated in FIG. 9. This suppresses enlargement of the beam spot of the laser beam B at the radiating position PT. Accordingly, the radiation intensity of the laser beam B onto the droplet Fb and accuracy of the radiating position are enhanced. Although the beam spot of the illustrated embodiment has a substantially circular shape larger than each of the data cells C (the droplets Fb), the shape of the beam spot is not restricted to this shape.

The electric circuit of the liquid ejection apparatus 20 will hereafter be explained with reference to FIG. 5.

As illustrated in FIG. 5, a control section 41 has a CPU, a RAM, and a ROM. The control section 41 performs procedures for moving the substrate stage 23 or operating the ejection head 30 or the laser head 36 in accordance with various data (regarding, for example, the movement speed of the substrate stage 23 or the cell width W) stored in the ROM and different control programs (such as an identification code formation program).

An input device 42 including a start switch and a stop switch is connected to the control section 41. The control section 41 receives operation signals and imaging data Ia representing an image of the identification code 10 from the input device 42. When receiving the imaging data Ia from the input device 42, the control section 41 performs a prescribed development process on the imaging data Ia. Further, to form the identification code 10, the control section 41 generates bit map data BMD indicating selected ones of the data cells C of the code formation area S onto which droplets Fb are to be ejected. The bit map data BMD is stored in the RAM. The bit map data BMD is 8×8 bit data corresponding to the data cells C. In accordance with the bit map data BMD, it is determined to whether to turn on or off the piezoelectric elements PZ (permit or prohibit ejection of the droplets Fb).

The control section 41 subjects the imaging data Ia to a development procedure different from the development procedure performed on the bit map data BMD. This generates the piezoelectric drive voltage VDP that drives each of the piezoelectric elements PZ and the laser drive voltage VDL that drives each of the semiconductor lasers LD.

An X-axis motor driver circuit 43 and a Y-axis motor driver circuit 44 are connected to the control section 41. The control section 41 sends a control signal to the X-axis motor driver circuit 43 for actuating the X-axis motor MX. The control section 41 sends a control signal to the Y-axis motor driver circuit 44 for actuating the Y-axis motor MY. In response to the control signal of the control section 41, the X-axis motor driver circuit 43 operates to rotate the X-axis motor MX in a forward or reverse direction, thus reciprocating the substrate stage 23. In response to the control signal of the control section 41, the Y-axis motor driver circuit 44 operates to rotate the Y-axis motor MY in a forward or reverse direction, thus reciprocating the carriage 27.

A substrate detector 45 is connected to the control section 41. The substrate detector 45 is capable of detecting an end of the substrate 2. In correspondence with a detection signal sent from the substrate detector 45, the control section 41 calculates the position of the substrate 2.

An X-axis motor rotation detector 46 and a Y-axis motor rotation detector 47 are connected to the control section 41. The X-axis motor rotation detector 46 and the Y-axis motor rotation detector 47 send detection signals to the control section 41.

The control section 41 detects the rotational direction and rotation amount of the X-axis motor MX in accordance with a detection signal sent from the X-axis motor rotation detector 46. The movement direction and the movement amount of the substrate 2 relative to the ejection head 30 are thus calculated. When the center of one of the data cells C coincides with the receiving position PF, the control section 41 provides an ejection timing signal SG to the ejection head driver circuit 48 and the laser driver circuit 49.

The control section 41 detects the rotational direction and rotation amount of the Y-axis motor MY in accordance with a detection signal sent from the Y-axis motor rotation detector 47. The movement direction and the movement amount of the substrate 2 relative to the ejection head 30 are thus calculated. As a result, the receiving position PF corresponding to the associated nozzle N is located on the movement path of the ejection target position P.

The ejection head driver circuit 48 is connected to the control section 41. The control section 41 generates a head control signal SCH by synchronizing the bit map data BMD corresponding to a single scanning cycle of the substrate 2 with a prescribed clock signal. The head control signal SCH is serially transferred to the ejection head driver circuit 48. Further, the control section 41 sends the piezoelectric element drive voltage VD to the head driver circuit 48 synchronously with a prescribed clock signal. The ejection head driver circuit 48 performs serial-parallel conversion on the head control signal SCH serially transferred from the control section 41 in correspondence with the piezoelectric elements PZ. In response to the ejection timing signal SG of the control section 41, the ejection head driver circuit 48 supplies the piezoelectric element drive voltage VDP to the piezoelectric element PZ corresponding to the head control signal SCH. In other words, the control section 41 ejects the droplet Fb from the nozzle N corresponding to the head control signal SCH (the bit map data BMD) through the ejection head driver circuit 48.

The laser driver circuit 49 is connected to the control section 41. The control section 41 serially transfers the head control signal SCH to the laser driver circuit 49 and supplies the laser drive voltage VDL to the laser driver circuit 49 synchronously with a prescribed clock signal. The laser driver circuit 49 converts the head control signal SCH, which has been serially transferred from the control section 41, into parallel signals in correspondence with the semiconductor lasers LD. The laser driver circuit 49 stands by for a predetermined time after having received the ejection timing signal SG from the control section 41. The laser driver circuit 49 then supplies the laser drive voltage VDL to the semiconductor laser LD corresponding to the head control signal SCH. That is, the control section 41 radiates the laser beam B from the semiconductor laser LD corresponding to the nozzle N from which the droplet has been ejected through the laser driver circuit 49.

In the following, the time from when the laser driver circuit 49 receives the ejection timing signal SG to when the laser driver circuit 49 supplies the laser drive voltage VDL will be referred to as the “standby time”. The standby time corresponds to the time from when the droplet Fb reaches the substrate 2 to when the droplet Fb reaches the radiating position PT. The laser driver circuit 49 stands by for a predetermined time after the droplet Fb has been ejected from the nozzle N. The laser driver circuit 49 then radiates the laser beam B from the semiconductor laser LD corresponding to the nozzle N from which the droplet Fb has been ejected when the outer diameter of the droplet Fb becomes equal to the cell width W.

A method for forming the identification code 10 using the liquid ejection apparatus 20 will hereafter be explained.

First, as illustrated in FIG. 2, the substrate 2 is fixed to the substrate stage 23 with the surface 2a facing upward. In this state, the substrate 2 is located rearward from the guide member 24 in direction X.

Subsequently, the imaging data Ia is input to the control section 41 through manipulation of the input device 42. The control section 41 then produces the bit map data BMD based on the imaging data Ia. Further, the control section 41 generates the piezoelectric element drive voltage VDP and the laser drive voltage VDL, which drive the piezoelectric elements PZ and the semiconductor lasers LD, respectively.

The control section 41 then actuates the Y-axis motor MY to transport the carriage 27 (the nozzles N) from the first position in direction Y in such a manner that each of the ejection target positions P passes the corresponding one of the receiving positions PF. Once the carriage 27 is set at a predetermined position, the control section 41 actuates the X-axis motor MX to move the substrate stage 23 in direction X, thus transporting the substrate 2.

The control section 41 determines whether the black cells C1 (the ejection target positions P) have reached the corresponding receiving positions PF in correspondence with detection signals sent from the substrate detector 45 and the X-axis motor rotation detector 46. When the black cells C1 move to the receiving positions PF, the control section 41 outputs the piezoelectric element drive voltage VDP and the head control signal SCH to the ejection head driver circuit 48. The control section 41 also supplies the laser drive voltage VDL and the head control signal SCH to the laser driver circuit 49. The control section 41 then stands by until the control section 41 must output the ejection timing signals SG to both of the ejection head driver circuit 48 and the laser driver circuit 49.

When the black cells C1 (the ejection target positions P) of the first row reach the corresponding receiving positions PF, the control section 41 sends the ejection timing signals SG to the ejection head driver circuit 48 and the laser driver circuit 49.

After having sent the ejection timing signals SG, the control section 41 supplies the piezoelectric element drive voltage VDP to the piezoelectric elements PZ corresponding to the head control signal SCH through the ejection head driver circuit 48. This causes the nozzles N corresponding to the head control signal SCH to eject the droplets Fb simultaneously. The outer diameter of the droplet Fb increases to the size equal to the cell width W by the time the droplet Fb reaches the radiating position PT from the receiving position PF (the ejection target position P) at which the droplet Fb has been received by the substrate 2.

After the ejection timing signal SG has been output, the control section 41 suspends for a predetermine time the radiation of the laser beam B from the semiconductor laser LD. Thereafter, the control section 41 supplies the laser drive voltage VDL to the semiconductor lasers LD that corresponds to the head control signal SCH. The control section 41 then causes the corresponding semiconductor lasers LD to simultaneously radiate the laser beams B. The laser beam B is totally reflected by the substrate 2 (the surface 2a) and the nozzle plate 31 (the reflective surface 31a) and then guided to the radiating position PT at the radiation angle θ2 (incident angle θ1: critical angle). The laser beam B is thus radiated onto the droplet Fb the outer diameter of which coincides with the cell width W. The energy generated by the laser beam B then evaporates the dispersion medium from the droplet Fb and bakes the metal particles of the droplet Fb. As a result, the dot D having the outer diameter equal to the cell width W is provided in the corresponding black cell C1 of the first row.

Afterwards, each time the target ejection positions P reach the corresponding receiving positions PF, the control section 41 operates to simultaneously eject the droplets Fb from the corresponding nozzles N in the above-described manner. When the outer diameter of each droplet Fb is equal to the cell width W, the laser head 36 is caused to simultaneously radiate the laser beams B onto the droplets Fb. In this manner, the dots D are formed in the code formation area S in accordance with a prescribed pattern, thus providing the identification code 10.

The illustrated embodiment has the following advantages.

(1) The reflective surface 31a, which reflects the laser beam B, is formed on the surface of the nozzle plate 31 opposed to the substrate 2. Therefore, after having been totally reflected by the surface 2a of the substrate 2 at the substrate reflecting position PR at the critical angle (the incident angle θ1), the laser beam B radiated from the laser head 36 is reflected also by the reflective surface 31a of the nozzle plate 31. As a result, the laser beam B is led to the radiating position PT on the surface 2a of the substrate 2 at the radiating angle θ2 (the incident angle θ1: the critical angle).

By reflecting the laser beam B at the surface 2a of the substrate 2 and the reflective surface 31a of the nozzle plate 31, the radiating angle θ2 of the laser beam B at the radiating position PT becomes smaller than that of the typical method illustrated in FIG. 9. This suppresses enlargement of the beam spot of the laser beam B at the radiating position PT. The radiation intensity of the laser beam B radiated onto the droplet Fb is thus enhanced. Further, the accuracy of the radiating position of the laser beam B, which is radiated onto the droplet Fb, is also improved, enhancing controllability for shaping the dots D.

(2) The reflective surface 31a of the nozzle plate 31 is employed as a reflecting member. The number of the components of the liquid ejection apparatus 20 is thus prevented from increasing. This makes it unnecessary to greatly modify the configuration of the liquid ejection apparatus 20. Further, the laser beam B that has been reflected at the substrate reflecting position PR can be radiated onto the radiating position PT without changing the distance (the platen gap) between the receiving position PF (the substrate 2) and the nozzle N (the ejection head 30). Thus, unlike a case in which the laser beam B is radiated with an increased platen gap, the accuracy of the receiving position of the droplet Fb is maintained.

(3) The reflective surface 31a of the nozzle plate 31 is coated with a liquid repellent film 31b, which repels the liquid F and is transmissible to the laser beam B. This prevents the reflective surface 31a of the nozzle plate 31 from being contaminated easily. This maintains the optical performance of the reflective surface 31a, stabilizing the radiation intensity of the laser beam B with respect to the droplet Fb and the accuracy of the radiating position of the laser beam B.

The illustrated embodiment may be modified in the following manners.

In the illustrated embodiment, the laser beam B may be reflected by the backside of the substrate 2 or the substrate stage 23. In other words, the laser beam B may be reflected in any suitable manner as long as reflection of the laser beam B occurs at the side corresponding to the substrate 2 and opposed to the ejection head 30.

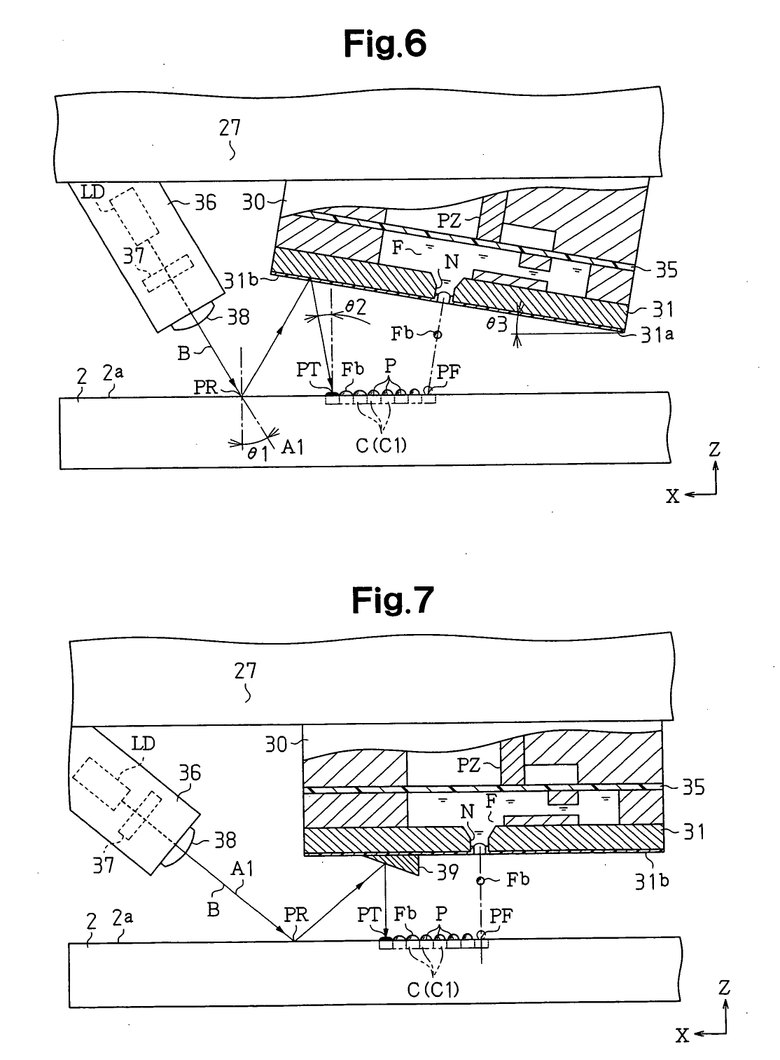

As illustrated in FIG. 6, the reflective surface 31a of the nozzle plate 31 may be inclined with respect to the surface 2a of the substrate 2 at the angle θ3 in such a manner that the distance between the nozzle plate 31 and the substrate 2 becomes greater in the vicinity of the laser head 36. This further reduces the radiating angle θ2 of the laser beam B radiated onto the radiating position PT.

As shown in FIG. 7, a reflective mirror 39 may be secured to the surface of the nozzle plate 31 as a reflecting member. In this configuration, by reflecting the laser beam B that has been reflected at the substrate reflecting position PR also by the reflective mirror 39, the laser beam B is guided to the radiating position PT in a direction perpendicular to the surface 2a of the substrate 2. In this case, the radiating angle θ2 is set to zero degrees. Alternatively, the reflective mirror 39 may be arranged forward from the nozzles N in the direction opposite to direction X. That is, the reflective mirror 39 may be provided at any other suitable position as long as the radiating angle θ2 decreases.

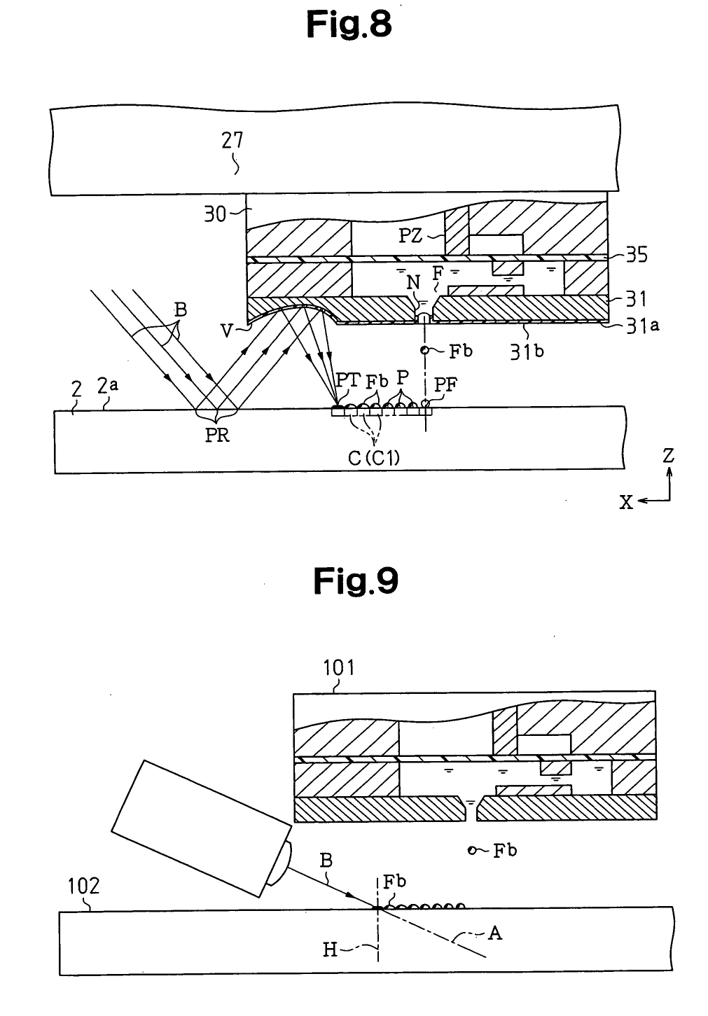

As shown in FIG. 8, a smooth recessed surface V may be formed in a portion of the reflective surface 31a. The recessed surface V reflects multiple laser beams B in such a manner that the laser beams B converge into a single beam at the radiating position PT. In this case, the laser beams B are further reliably guided to the radiating positions PT. Alternatively, the recessed surface V may be provided on the entire area of the reflective surface 31a. In other words, the recessed surface V may be arranged at any other suitable position as long as the laser beams B that have been reflected by the surface 2a of the substrate 2 are converged at the radiating position PT.

In the illustrated embodiment, multiple reflection of the laser beams B may be brought about between the surface 2a of the substrate 2 and the reflective surface 31a of the nozzle plate 31.

In the illustrated embodiment, the droplets Fb may be caused to flow in a desired direction using energy generated by the laser beams B. Alternatively, by radiating the laser beam only to the outer peripheral end of each droplet Fb, the surface of the droplet Fb may be solidified (pinned) exclusively. In other words, the present invention may be applied to any other suitable method by which dots are formed through radiation of the laser beams B onto the droplets Fb.

In the illustrated embodiment, a carbon dioxide gas laser or a YAG laser may be used as a laser radiation source. That is, any suitable laser radiation source may be employed as long as the wavelength of the radiated laser beam B causes drying of the droplet Fb.

In the illustrated embodiment, instead of the semispherical dots D, the droplets Fb may form oval dots or linear structures.

The present invention may be applied to a method for forming a pattern of an insulating film or metal wiring of a field effect type device (FED or SED). The field effect type device emits light from a fluorescent substance using electrons released from a flat electron release element. In other words, the present invention may be applied to any other suitable method for forming patterns by radiating laser beams B onto droplets Fb.

In the illustrated embodiment, the substrate 2 may be, for example, a silicone substrate, a flexible substrate, or a metal substrate.

1. A method for forming a pattern by ejecting droplets of a liquid containing a pattern forming material from ejection ports defined in an ejection head opposed to a substrate and radiating a laser beam onto the droplets on the substrate, the method comprising:
radiating the laser beam onto the substrate and reflecting the laser beam by the substrate; and
reflecting the laser beam that has been reflected by the substrate onto areas of the substrate in which the droplets have been received by the substrate by a reflecting member provided in the vicinity of the ejection ports.

2. The method according to claim 1, wherein the laser beam reflected by the substrate is reflected by the reflecting member in a direction perpendicular to the substrate.

3. The method according to claim 1, wherein the laser beam reflected by the substrate is converged by the reflecting member in each of areas of the substrate in which the droplets have been received by the substrate.

4. A liquid ejection apparatus including an ejection head having an ejection port opposed to a substrate and ejecting a droplet of a liquid from the ejection port and a laser source radiating a laser beam onto the substrate, the apparatus comprising a reflecting member that is provided in the vicinity of the ejection port and reflects the laser beam that has been reflected by the substrate, wherein the reflecting member reflects the laser beam that has been reflected by the substrate toward an area of the substrate in which the droplet has been received by the substrate.

5. The apparatus according to claim 4, wherein the reflecting member is formed by a nozzle plate that has the ejection port.

6. The apparatus according to claim 5, wherein a surface of the nozzle plate opposed to the substrate is formed through mirror surface machining.

7. The apparatus according to claim 4, wherein the reflecting member is coated with a liquid repellent film that is transmissible to the laser beam and repels the liquid.

8. The apparatus according to claim 4, wherein the reflecting member has a reflective surface that reflects the laser beam that has been reflected by the substrate in a direction perpendicular to the substrate.

9. The apparatus according to claim 4, wherein the reflecting member has a reflective surface that converges laser beams that have been reflected by the substrate in an area of the substrate in which the droplet has been received by the substrate.

10. The apparatus according to claim 4, wherein the laser beam radiated by the laser source is totally reflected by a surface of the substrate.

11. The apparatus according to claim 7, wherein the liquid repellent film is formed of a silicone resin or fluorine resin.
